(19) United States
(12) Patent Application Publication
(10) Pub. No.: US 2025/0368394 A1
(43) Pub. Date: Dec. 4, 2025

(54) ALUMINUM PACKAGING CONTAINER, PACKAGED PRODUCT AND METHOD

(71) Applicant: AMCOR FLEXIBLES NORTH AMERICA, INC., Neenah, WI (US)

(72) Inventors: Lionel Sylvain Olivier CARRE, Chaudenay (FR); Lucas Franck CYROT, Chalon Sur Saone (FR)

(21) Appl. No.: 18/873,669

(22) PCT Filed: Jun. 28, 2022
(86) PCT No.: PCT/US2022/035225

§ 371 Date: Dec. 10, 2024

(51) Int. Cl. B65D 25/14; B21D 22/20; B65D 1/26

(52) U.S. Cl. CPC B65D 25/14; B21D 22/20; B65D 1/26

(57) ABSTRACT

A packaged product includes an aluminum container, a product, and a lidding material. The aluminum container includes a sidewall having an interior surface, a sealable extension that includes the interior surface and a flat portion, an opening having a diameter in a range of from 30 mm to 100 mm, and a height in a range of from 30 mm to 100 mm. The lidding material includes a polypropylene sealing layer. The interior surface includes a heat seal varnish. A seal between the polypropylene sealing layer and the interior surface of the sealable extension includes a peelable hermetic seal. The heat seal varnish may include a polypropylene wax dispersed in a polyester matrix. The product may include an alcohol content in a range of from 5% to 50%.

### TECHNICAL FIELD

This disclosure is related to a packaged product contained in an aluminum-based package. The package includes an aluminum container and a lid that forms a hermetic, peelable seal with the aluminum container. The packaged product may include an alcohol content that the package is especially suited to contain. The package may be recyclable.

### BACKGROUND

Many packages are designed to hold single servings of food, beverages, other liquids, or non-food products. The packages include a lid component that is hermetically sealed to a container component thereby reducing spoilage of the product contained in the package. Many packages include, (a) a polymeric-based container (e.g., high density polyethylene (HDPE) or polyethylene terephthalate (PET) and a peelable, flexible film lid that is peeled from the container to open the package (e.g., yogurt cups, pudding cups), (b) a polymeric-based container and a flexible film, non-peelable lid that is punctured or ruptured to open the package and gain access to the product (e.g., single-serve coffee pods), (c) a metal-based or fiber-based container and a metal-based peel-off end (POE) (e.g., single-serve canister potato chip packages), and (d) a metal-based container and a metal-based, non-peelable lid that is punctured or ruptured to access the product (e.g., single-serve coffee capsules).

Some container and lid combinations for single-serve packages are not suitable to contain products having moisture content, such as beverages or food packed in liquid, unless a barrier is included on the inside or the outside of the container. Barriers include, for example, PET or PET-based film or film laminates including PET and having a thickness ranging from approximately 30 microns to 500 microns. Packages that contain acidic or alcoholic products are further subject to container corrosion and dissolution of the hermetic seal (e.g., materials forming an airtight seal) between the container and lid. The barriers that protect containers from corrosion or loss of hermeticity deter peelable removal of the lid from the container because the bond strength between the lid and container is too high for a user to be able to peel the lid from the container.

Additionally, global demand for plastic waste reduction and sustainable packaging solutions is on the rise. The package components often cannot be recycled due to the combination of materials that include (a) metal and polymer, or (b) a variety of polymers that provide barrier to prevent the ingress of oxygen and/or moisture into the package. The combination of materials can create difficulties when determining how to dispose of the packaging components after use.

### SUMMARY

This disclosure relates to an aluminum container and a packaged product contained in an aluminum-based package and in particular, packages that contain relatively small volumes of a product, for example single servings of food, non-food, or beverage items. The package includes an aluminum container that includes a heat seal varnish on the interior of the container. The specialized heat seal varnish provides corrosion resistance to the aluminum container and allows a peelable, hermetic seal to be formed between the container and a lid. The disclosure includes a method of making an aluminum container.

The package can be used for packaging a wide variety of products that are not restricted to food, beverages, cosmetics, lotions, or pharmaceuticals. The package is especially suited to contain products that include corrosive contents, for example, those including an alcohol content. A non-limiting package example includes a package that resembles a shot glass having a sealed, peelable lid for transporting a small volume of an alcoholic beverage. The lid is peelably removed from the aluminum container allowing a user to use or consume the beverage.

A lid including aluminum may be sealed to the aluminum container. A high aluminum content of the lid and container may allow the package to be recyclable.

In a first embodiment, an aluminum container comprises a sidewall. The aluminum container comprises an interior surface, a sealable extension comprising the interior surface and having a flat portion, an opening having a diameter in a range of from 30 mm to 100 mm, and a height in a range of from 30 mm to 100 mm. The interior surface may comprise a heat seal varnish that may comprise a polypropylene wax dispersed in a polyester matrix. A seal between the interior surface of the sealable extension and a lidding material comprising a polypropylene sealing layer comprises a peelable hermetic seal.

In a second embodiment, a packaged product comprises an aluminum container comprising a sidewall comprising an interior surface, a sealable extension comprising the interior surface and having a flat portion, an opening diameter having a range of from 30 mm to 50 mm, and a height having a range of from 50 mm to 70 mm. The packaged product may comprise a product comprising a product volume in a range of from 25 ml to 70 ml. The packaged product may comprise a lidding material comprising aluminum and a polypropylene sealing layer. The interior surface may comprise a heat seal varnish comprising a polyester matrix comprising a polypropylene wax. A seal between the polypropylene sealant and the interior surface of the sealable extension may comprise a peelable hermetic seal.

In a third embodiment, a method of making an aluminum container includes the operations of feeding, coating, drying, punching, and forming. For a feeding operation, in one or more embodiments, an aluminum sheet having a first surface and a second surface is fed into a coating station. For a coating operation, in one or more embodiments, the aluminum sheet first surface is coated with a heat seal varnish in a wet state. For a drying operation, in one or more embodiments, the heat seal varnish is dried to a dry state. For a punching operation, in one or more embodiments, an aluminum container is punched from the aluminum sheet and comprises an interior surface comprising the aluminum sheet first surface and an exterior surface comprising the aluminum sheet second surface. For the forming operation, in one or more embodiments, a sealing extension is formed comprising the interior surface and having a flat portion. The heat seal varnish comprises the interior surface.

Other features that may be used individually or in combination with respect to any embodiment are as follows.

The sealable extension may further comprise a curved portion.

The flat portion may comprise a width in a range of from 1.0 mm to 5.0 mm.

The diameter may have a range of from 30 mm to 50 mm.

The heat seal varnish may comprise a dry coat weight in a range of from 3.0 grams per meter² (gsm) to 9.0 gsm.

The aluminum container may comprise an aluminum content of from 90% to 100% by weight of the aluminum container.

The lidding material may further comprise aluminum. The lidding material may further comprise an aluminum content of from 90% to 100% by weight of the lidding material.

The aluminum container may comprise an oxygen transmission rate of less than 0.005 cubic centimeters per meter² per 24 hours (cc/m²/24 hours) when measured at 23° C. and 0% relative humidity (RH) using ASTM D3985-05.

The product may comprise a liquid.

The product may have an alcohol content in a range of from 5% to 50%.

The packaged product may further comprise an aluminum content of from 90% to 100% by weight of a combination of the aluminum container and the lidding material.

The method may further comprise a printing and/or coating operation comprising applying printed indicia and/or a coating to the aluminum container exterior surface before the punching operation.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a schematic perspective view of an embodiment of an aluminum container;

FIG. 2 illustrates a schematic cross-sectional view of the aluminum container shown in FIG. 1;

FIG. 3 illustrates a schematic cross-sectional view of another embodiment of an aluminum container;

FIG. 4 illustrates a schematic partial view of the sealing extension shown in FIG. 3;

FIG. 5 illustrates a schematic cross-sectional view of a further embodiment of an aluminum container;

FIG. 6 illustrates a schematic partial view of the sealing extension shown in FIG. 5;

FIG. 7 illustrates a schematic cross-sectional view of an embodiment of a lidding material;

FIG. 8 illustrates a schematic perspective view of an embodiment of a packaged product; and

FIG. 9 illustrates a flowchart depicting method steps of making an aluminum container in accordance with an embodiment of the present disclosure.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Described herein are aluminum containers and packaged products that include the aluminum container, a lidding material, and a product. The aluminum container includes a heat seal varnish that allows the lidding material to be sealed (e.g., heat sealed) to the aluminum container creating a package that contains a product thus forming a packaged product. The heat seal varnish provides for peelable functionality between the lid and the aluminum container and for corrosion resistance from the product contained in the package (i.e., aluminum container, heat seal varnish, and lid). The package may be recyclable, for example when the package includes at a minimum, 90% of aluminum by weight of the package. In some embodiments, the aluminum container may remain attached to the lidding material such that the entire package may be recycled together without the lidding material and container being separated from each other.

The package can contain small volumes of product, for example, single servings of food or beverage. The product may be sensitive to oxygen and/or moisture such that barrier materials may be included in the lid to prevent the ingress of oxygen and/or moisture.

The package of the present disclosure has the distinct advantage of being able to contain liquids having an alcohol content in a range of from 5% to 50% while maintaining barrier and resisting corrosive effects of alcohol. Further, a hermetical seal is maintained between the aluminum container and the lidding material until the lidding material is peelably removed from the aluminum container. These advantages are achieved with the heat seal varnish coated on an interior surface of the aluminum container.

### Aluminum Container

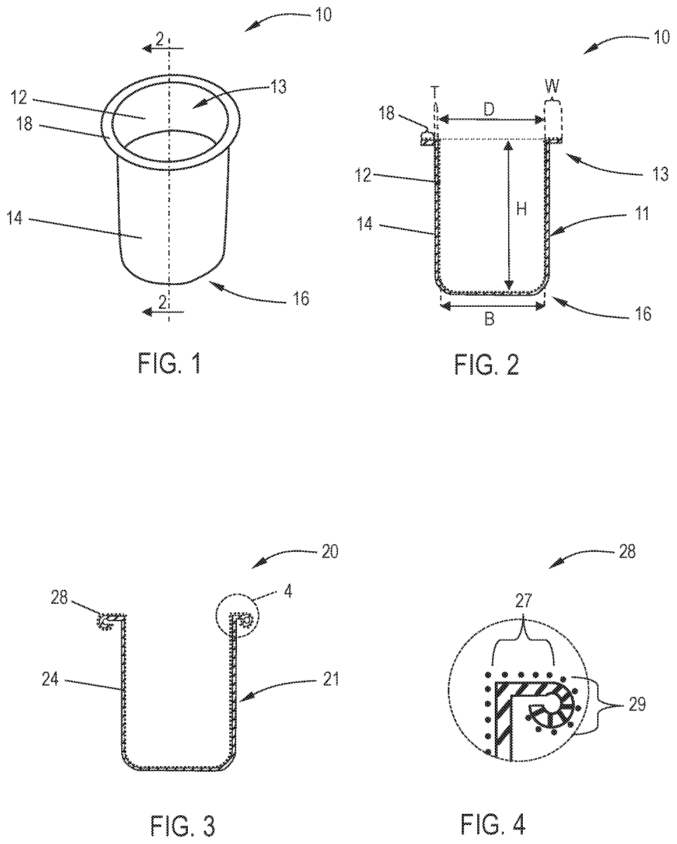

With reference to FIG. 1, an aluminum container 10 includes a sidewall 11 that includes an interior surface 12 and an exterior surface 14. FIG. 2 shows a cross-sectional view of the aluminum container 10 shown in FIG. 1 taken along line 2-2. A heat seal varnish is coated onto the interior surface 12 and is shown as a dotted line in FIG. 2. The aluminum container 10 includes an open end 13 (e.g., opening, top of container) that forms an opening and a closed end 16 (e.g., bottom of container) that opposes the open end 13.

The aluminum container is produced from aluminum or aluminum alloys that are suitable for containing a packaged product and for drawing or punching operations as known by one of skill in the art. An exemplary alloy includes AA8011A as defined in the standard DIN EN 573-3. In some embodiments the aluminum container includes 90% or greater of aluminum by weight of the aluminum container. The aluminum container may include aluminum in a range of from 90% to 100% aluminum by weight of the aluminum container, or any combination of ranges therebetween.

The aluminum container opening includes a diameter that may be in a range of from 30 mm to 100 mm (1.18 inches to 3.94 inches). With reference to FIG. 2, the diameter D is the distance across the open end 13 of the aluminum container 10 as measured between opposing sides of the interior surface 12 (i.e., measured across the opening). In some embodiments, the diameter may include a range of from 30 mm to 40 mm, 40 mm to 50 mm, 50 mm to 60 mm, 60 mm to 70 mm, 70 mm to 80 mm, 80 mm to 90 mm, 90 mm to 100 mm, or any range or combination of ranges therein.

The aluminum container includes a height that may be in a range of from 30 mm to 100 mm (1.18 inches to 3.94 inches). With reference to FIG. 2, the height H is the distance from a plane that includes the open end 13 to the interior surface 12 of the closed end 16 of the aluminum container 10. In some embodiments, the height may include a range of from 30 mm to 40 mm, 40 mm to 50 mm, 50 mm to 60 mm, 60 mm to 70 mm, 70 mm to 80 mm, 80 mm to 90 mm, 90 mm to 100 mm, or any range or combination of ranges therein. Accordingly, the aluminum container may have a volume in a range of from 20 ml to 786 ml.

In some embodiments, a ratio of the height to the diameter (e.g., draw ratio) may be in a range of from 0.3 to 3.3, 0.5 to 3.0, 0.7 to 2.8, 0.9 to 2.6, 1.0 to 2.4, 1.2 to 2.2, 1.4 to 2.0, 1.6 to 1.8, or any range or combination of ranges therein. In an embodiment, the ratio of the height to the diameter may be in a range of from 1.8 to 2.2. In an embodiment, the ratio of the height to the diameter may be 2.0. The aluminum container of the disclosure is particularly suited for high ratios of the height to the diameter (e.g., deep draw ratios), for example, ratios equal to or greater than 1.1.

The aluminum container may include a shape that is cylindrical, such as the shape of the aluminum container 10 shown in FIGS. 1-2. Aluminum containers that include a cylindrical shape include a bottom diameter that is approximately equal to the diameter (e.g., opening diameter). With reference to FIG. 2, a bottom diameter B is the distance across the closed end of the aluminum container 10 as measured at the interior surface 12 of opposing sidewalls 11. The aluminum container may also include a shape that is conical where in one example, a bottom diameter may be greater than a diameter, and in another example, a bottom diameter may be less than a diameter. Further, the aluminum container may have a shaped open end and corresponding shaped closed end. The open end 13 and closed end 16 in FIGS. 1-2 are shown to be circular. The open end and corresponding closed end may have an elliptical, polygonal, or other shape.

The aluminum container may have an exterior surface that is smooth or textured. The sidewall may include formations such as ridges or embossing to include other patterns or characters, for example letters or numbers. The exterior surface 14 of the sidewall 11 in FIGS. 1-2 is shown as a smooth surface. The aluminum sidewall may include printed indicia on the exterior surface that may be applied in any manner known by one of skill in the art.

The aluminum sidewall 11 includes a thickness T in a range of from 150 microns to 270 microns, 160 microns to 260 microns, 170 microns to 250 microns, 180 microns to 240 microns, 190 microns to 230 microns, 180 microns to 220 microns, 190 microns to 210 microns, 200 microns to 205 microns, or any range or combination of ranges therein. In an embodiment, the thickness may be in a range of from 180 microns to 270 microns. In an embodiment, the thickness may be 230 microns.

The aluminum container includes a sealing extension that includes a flat portion (e.g., flange). The sealing extension includes a portion of the aluminum sidewall that extends laterally away from the opening. The sealing extension 18 shown in FIGS. 1-2 is a flat extension of a sidewall 11 from the opening. A width W of the sealing extension includes a measurement of the distance where a flat portion begins at a vertical portion of the interior surface from where the flat portion extends laterally away from the opening to the end of the flat portion. The sealing extension 18 includes only a flat portion. The sealing extension includes a flat portion for optimal sealing to a lidding material. The width of the sealing extension may be in a range of from 1.0 mm to 5.0 mm, from 2.0 mm to 4.0 mm, or any range or combination of ranges therein. In an embodiment, the sealing extension width may be from 2.0 mm to 3.0 mm or any range therein.

With reference to FIGS. 3-4, another embodiment of an aluminum container 20 is shown. The aluminum container 20 includes a sealing extension 28 that includes a flat portion 27 of a sidewall 21 and a curved (e.g., rolled) portion 29 such that the edge of the sidewall 21 is rolled towards an exterior surface 24 of the sidewall 21 that is the underside of the sealing extension 28. FIG. 4 includes a partial view of the sealing extension 28 shown in FIG. 3 at circle 4. A sealing extension that includes a curved portion may provide a smooth edge and prevent injury to a user, for example, while handling or drinking from the aluminum container.

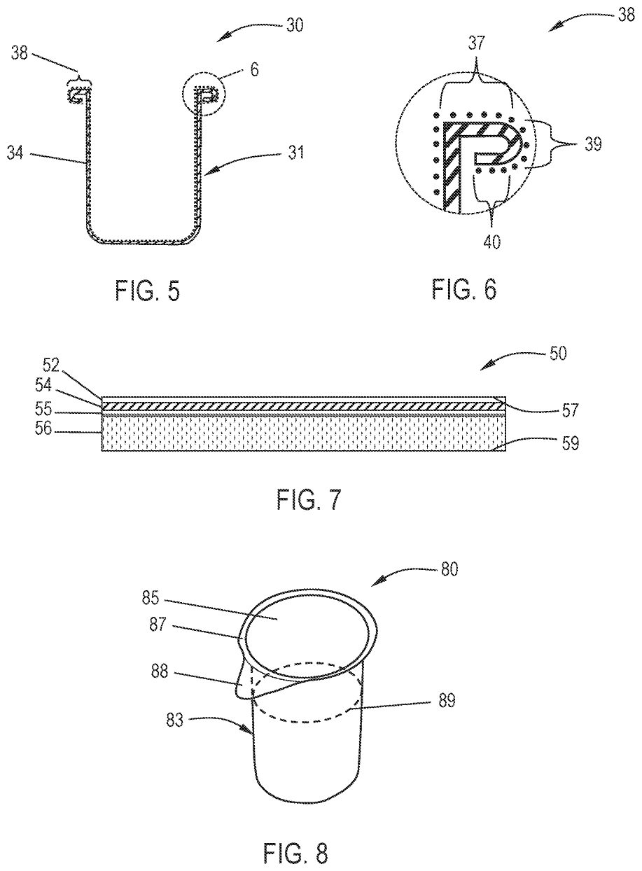

With reference to FIGS. 5-6, another embodiment of an aluminum container 30 is shown. The aluminum container 30 includes a sealing extension 38 that includes a flat portion 37 of a sidewall 31, a curved portion 39, and an additional flat portion 40 such that the edge of the sidewall 31 is rolled towards an exterior surface 34 of the sidewall 31. FIG. 6 includes a partial view of the sealing extension 28 shown in FIG. 5 at circle 6. The sealing extension or portions of the sealing extension may extend in a plane that is parallel to the bottom end either completely, as shown in FIGS. 1-2, or partially, as shown in FIGS. 3-6.

### Heat Seal Varnish

The heat seal varnish (e.g., lacquer, coating) is formulated to: (a) provide heat seal capability to the aluminum container that allows it to be heat sealed to a lidding material (e.g., lid) that includes a polymer-based sealant material, (b) provide a hermetic seal between the container and lid that forms a package, (c) allow the hermetic seal to be opened (e.g., broken) by peeling the lid away from the aluminum container, and (d) provide corrosion resistance to the aluminum container from highly acidic or alcoholic products contained within the package. In an embodiment, the heat seal varnish may allow the aluminum container to be heat sealed to a lidding material that includes polypropylene (e.g., polypropylene-based sealant layer). In some embodiments, the heat seal varnish may include a pigment or other colorant.

Another feature provided by the heat seal varnish includes prevention of aluminum cracking when the aluminum is processed (e.g., punched, drawn) to form the aluminum container. The heat seal varnish can further be a food grade varnish and regulate oxygen transmission to avert product oxidation. Oxidation of product can negatively affect product flavor (e.g., food, beverage, or alcoholic products) and product color. The oxygen transmission rate of the aluminum container may be less than 0.005 cubic centimeters per meter² per 24 hours (cc/m²/24 hours) when measured at 23° C. and 0% relative humidity (RH) using ASTM D3985-05.

The flavor and color of liquid product that includes an alcohol content can be measured when the product is originally filled in the aluminum container and measured again after the product has aged in the package. The flavor of liquid products that include an alcohol content can be measured according to “Sensory analysis-Methods for Assessing Modifications to the Flavour of Foodstuffs Due To Packaging”, ISO 13302: 2003. The color of liquid products that include an alcohol content can be measured according to “Compendium of International Methods of Analysis of Spirituous Beverages of Vitivinicultural Origin—Determination of chromatic characteristics”, OIV-MA-BS-27, or “Compendium of International Analysis of Methods—Determination of chromatic characteristics according to CIELab”, OIV-MA-AS2-11. The heat seal varnish of the present disclosure causes little to no change when comparing the aged measurement to the original measurement of an aged liquid alcoholic product.

The heat seal varnish includes a polypropylene wax that is dispersed in a polyester matrix accompanied by suitable solvents (e.g., food grade solvents). The heat seal varnish includes a solids content in a range of from 35% to 60%, 40% to 55%, 45% to 50%, or any range or combination of ranges therein that is indicative of the percent solids by weight in a wet state of the heat seal varnish. The solids content is measured according to “Paints, varnishes and plastics-Determination of non-volatile-matter-content”, ISO 3251: 2019. In an embodiment, the heat seal varnish solids content may be in a range of from 44% to 48% by weight of the heat seal varnish in a wet state. In an embodiment, the heat seal varnish solids content may be 46% by weight of the heat seal varnish in a wet state.

As used throughout this application, the term “polyester” refers to a homopolymer or copolymer having an ester linkage between monomer units which may be formed, for example, by (a) condensation polymerization reactions between a dicarboxylic acid and a diol, (b) condensation reaction of hydroxy acids, or (c) ring opening of glycolide, lactide, (d) transesterification of a diol and a diester known as bis-HET, etc. The ester linkage can be represented by the general formula: [O—R—OC(O)—R′—C(O)]ₙ where R and R′ are the same or different alkyl (or aryl) group and may be generally formed from the polymerization of dicarboxylic acid and diol monomers containing both carboxylic acid and hydroxyl moieties. The dicarboxylic acid (including the carboxylic acid moieties) may be linear or aliphatic (e.g., lactic acid, oxalic acid, maleic acid, succinic acid, glutaric acid, adipic acid, pimelic acid, suberic acid, azelaic acid, sebacic acid, and the like) or may be aromatic or alkyl substituted aromatic (e.g., various isomers of phthalic acid, such as paraphthalic acid (or terephthalic acid), isophthalic acid and naphthalic acid). Specific examples of a useful diol include but are not limited to ethylene glycol, propylene glycol, trimethylene glycol, 1,4-butane diol, neopentyl glycol, 1,4-cyclohexane dimethanol (CHDM), cyclohexane diol, and the like. Polyesters may include (a) a homopolymer or copolymer of alkyl-aromatic esters including but not limited to polyethylene terephthalate (PET), amorphous polyethylene terephthalate (APET), crystalline polyethylene terephthalate (CPET), glycol-modified polyethylene terephthalate (PETG) and polybutylene terephthalate, (b) a copolymer of terephthalate and isophthalate including but not limited to polyethylene terephthalate/isophthalate copolymer, (c) a homopolymer or copolymer of aliphatic esters including but not limited to polylactic acid (PLA), (d) polyhydroxyalkonates including but not limited to polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D), (e) polyethylene furanoate (PEF), and blends of any of these materials.

As used throughout this application, the term “polypropylene” or “PP” refers to a homopolymer or copolymer having at least one propylene monomer linkage within the repeating backbone of the polymer. The propylene linkage can be represented by the general formula: —CH₂—CH(CH₃)—.

### Lidding Material

A lidding material (e.g., lid, lidding) can be heat sealed to the flat portion of the sealing extension that includes the heat seal varnish providing a peelable, hermetic seal and forming a package. Lidding material should be selected carefully to maintain the oxygen barrier provided by the heat seal varnish coated aluminum container. Lidding material often includes multiple layers of polymeric films, other substrates, or coatings to achieve the desired properties that may include barrier, sealing functionality, and abuse resistance to an environment external to the sealed package. The lidding material is not limited to any particular structure other than having the capability to maintain the package oxygen barrier, including a sealing layer including polypropylene, and having capability to form a hermetic, peelable seal with the heat seal varnish positioned on the interior surface of the aluminum container.

As used herein, the term “film” is a monolayer or multilayer web that has an insignificant z-direction dimension (thickness) as compared to the x- and y-direction dimensions (length and width). Films are generally regarded as having two major surfaces, opposite each other, expanding in the length and width directions.

The term “layer”, as used herein, refers to a building block of films that is a structure of a single polymer or a homogeneous or heterogeneous blend of materials. A layer may contain other non-polymeric materials and may have additives. Layers may be continuous or discontinuous (i.e., patterned) with the length and width of the film. In a monolayer film, “film”, “sheet” and “layer” are synonymous.

The term “multilayer”, as used herein, refers to a single substrate structure (e.g., film, ply, etc.), which may have a plurality of layers, generally in the form of a sheet or web that can be made from a polymeric material or a non-polymeric material bonded together by any conventional means known in the art, (i.e., coextrusion, lamination, coating, or a combination thereof).

Multilayer structures include as many layers as desired and, preferably, at least two layers. In multilayer structures that include at least three layers, the structure includes an inner layer. As used throughout this application, the term “inner layer” refers to a layer that is positioned between two other layers. As used throughout this application, the term “surface layer” refers to a layer that does not have another layer on at least one of its major surfaces, (i.e., a surface layer that is on the exterior of the multilayer structure).

The lidding material may include monolayer films and/or multilayer films that may include a barrier layer. The term “barrier layer”, as used herein, refers to a layer that significantly reduces the transmission of one or more molecular species through the layer. A barrier layer may be a surface layer or an inner layer of the lidding. A barrier layer may limit or reduce the permeation of migratory species such as moisture, oxygen, and/or other gasses. Barrier layers typically include metals or polymers that are referred to as “barrier materials”. Barrier polymeric materials useful for lidding include but are not limited to polymers including ethylene vinyl alcohol copolymer (EVOH), PVDC, high density polyethylene (HDPE), cyclic olefin copolymers (COC), polyamides, polyacrylates, and polypropylenes. Barrier metallic materials useful for lidding may include aluminum or polymeric films coated with metal oxides. Barrier layers may include blends of materials. The lidding may contain multiple barrier layers, that is, a second barrier layer, a third barrier layer, and so on.

In some embodiments, the barrier material includes an ethylene vinyl alcohol copolymer. The terms “ethylene vinyl alcohol copolymer” or “EVOH”, as used herein, refer to copolymers comprised of repeating units of ethylene and vinyl alcohol. Ethylene vinyl alcohol copolymers can be represented by the general formula: [(CH₂—CH₂)ₘ—(CH₂—CH(OH))ₙ]. Preferably, ethylene vinyl alcohol copolymers comprise from about 25 mole percent to about 48 mole percent ethylene. EVOH is known to reduce the permeation of oxygen and other gasses through polymeric based packaging films. EVOH includes a density from 1.12 g/cm³ to 1.24 g/cm³.

The barrier layer may provide moisture barrier. Some embodiments of the barrier layer may include high density polyethylene (HDPE) for moisture barrier improvements. The terms “high density polyethylene” or “HDPE”, as used herein, refer to both (a) homopolymers of ethylene that may have densities from about 0.960 g/cm³ to about 0.970 g/cm³ and (b) copolymers of ethylene and an alpha-olefin (usually 1-butene or 1-hexene) that may have densities from about 0.940 g/cm³ to about 0.958 g/cm³. HDPE includes polymers made with Ziegler or Phillips type catalysts, polymers made with single-site metallocene catalysts, and polymers made with non-metallocene single-site catalysts. HDPE also includes high molecular weight polyethylenes.

Some embodiments of the barrier layer may include polypropylene (PP) for moisture barrier improvements. The lidding may include one, two, three, four, or more separate layers comprising PP, each consisting essentially of PP. That is, the PP may be accompanied by other minor components such as slip, antiblock, processing aid, nucleation additives, or hydrocarbon additives, such that the blend consists of at least 80% PP. In some embodiments, the lidding film may include more than one barrier layer where each barrier layer includes a barrier material that is different from at least one of the other barrier layers.

The lidding material includes a sealant film that includes a sealing layer including polypropylene. The sealing layer may be a monolayer film or multilayer film or includes coatings that include polypropylene. The sealant film should be capable of forming a bond upon exposure to heat and pressure for a short dwell time to form a heat seal. The sealant film may be a monolayer or a multilayer film. The sealing layer may be a monolayer film that is the sealant film. In the case of a multilayer sealant film, a sealing layer may be a surface layer or may include more than one layer that may be intricately involved in sealing. In some cases, the sealing layer may include a heat seal coating. Persons having ordinary skill in the art may set appropriate heat sealing conditions for a given application. In an embodiment, the heat sealing conditions may include a 1 second dwell time, an upper jaw temperature of 220° C., a lower jaw temperature of 130° C., and a pressure of 600 N.

Still another object of the disclosure is to provide a peelable seal between the aluminum container and the lidding material such that the package is manually openable. As used herein, the term “peelable seal” refers to a seal that can be opened manually (i.e., by hand without the use of tools). A manually openable package is one in which the peel strength of the lidding material to the aluminum container can be controlled over a wide temperature range. As used herein, “peel strength” is the measure of the average force to part two bonded materials like tape, labels, textile, or plastic films. Peelable seals are generally defined within the packaging industry as seals that can be separated by a peel strength (e.g., force) of less than 2,500 g/24.5 mm when measured according to ASTM F88/F88M-09. It is important that the seal between the aluminum container and the lidding material have sufficient seal strength to remain secure, unbroken, and airtight (i.e., hermetic) during package fabrication, distribution, and storage that is generally defined by a peel strength of at least about 150 g/24.5 mm. The range of the peel strengths listed in the present disclosure shall be wide enough to cover both peak and average peel strengths, however the present disclosure is not to be limited by the peel strengths in any manner other than the seal remaining hermetic until a user peelably removes the lid from the aluminum container. In an embodiment, the heat seal between the aluminum container and lidding material is hermetic and can readily peel apart by hand without uncontrolled or random tearing or rupturing of the container and/or lidding material.

In some embodiments the lidding material includes 90% or greater of aluminum by weight of the lidding material. The lidding material may include aluminum in a range of from 90% to 100% aluminum by weight of the lidding material, or any range or combination of ranges therebetween.

The lidding material may include printed indicia. The printed indicia may be positioned between layers of a multilayer film lidding material. The printed indicia may be surface printed on a monolayer film lidding material. The lidding material may further include coatings or lacquers on the surface exposed to an external environment of the package. The coatings or lacquers may provide abuse resistance or aesthetics, among other things as known in the art, to the lidding material.

With reference to FIG. 7, a cross-sectional view of an exemplary lidding material is shown. Lidding material 50 includes a first layer 52, a second layer 54, and a third layer 56. The first layer 52 includes a lacquer that is applied to the second layer 54. The first layer 52 is a surface layer that may be exposed to an environment external to a packaged product that includes the lidding material 50. The second layer 54 includes a barrier layer that includes aluminum. The third layer 56 includes a sealing film that includes a sealing layer that includes polypropylene. The third layer 56 is a surface layer that may be exposed to an environment internal to a packaged product that includes the lidding material 50. The second layer 54 and the third layer 56 are laminated to each other with a lamination layer 55 that may include an adhesive or laminating agent or material. Any layers of the lidding material may be laminated to each other by any lamination methods known by one of skill in the art. For example, layers may be joined by adhesive, extrusion lamination, coating, heat, coextrusion, etc. The lidding material 50 includes a first surface 57 and a second surface 59. The second surface 59 can be sealed to the heat seal varnish on the sealing extension that forms a seal with the interior surface of the aluminum container.

### Packaged Product

A packaged product of the disclosure includes the aluminum container and the lidding material previously described, and a product. The product is placed into the aluminum container and the lidding material is heat sealed to the aluminum container.

Products that may be contained in the package are not limited to food, food packed in liquid, liquids, beverages, pharmaceuticals, nutraceuticals, or non-food products, such as medical products, consumer goods, cosmetics, lotions, and chemicals. The package is especially suited to contain products that include corrosive contents, for example, those having acidic (e.g., tomatoes, citrus juice, etc.) or alcoholic content.

The product includes a moisture content from 0% to 100% by weight of the product. The term “moisture content”, as used herein, refers to the weight of the water contained in a product and is expressed as a percentage of the product weight. A moisture content of 0% indicates that the product is completely dry and a moisture content of 100% indicates that the product is completely saturated with liquid. The liquid may include an alcohol content in a range of from 5% to 50%. The term “alcohol content”, as used herein, refers to alcohol by volume (ABV) and is a standard measure of how much alcohol (i.e., ethanol) is contained in a given volume of an alcoholic beverage and is expressed as a volume percent.

The product volume contained in the package may be similar to the volume of the aluminum container that may be in a range of from 20 ml to 786 ml. The product volume may be less than the aluminum container volume to allow for headspace inside of the package and/or for manufacturing efficiencies such that product is not spilled or wasted when the lidding material is sealed to the aluminum container. In some embodiments, the product volume reflects a single serving of the product. For example, nutritional labels found on packaged food products in the United States include a serving size that represents a recommended amount of the food to be consumed in a single serving (e.g., at one time). In an embodiment, a product volume may be in a range of from 20 ml to 30 ml, 30 ml to 40 ml, 40 ml to 50 ml, 50 ml to 60 ml, 60 ml to 70 ml, 70 ml to 80 ml, 80 ml to 90 ml, 90 ml to 100 ml, 100 ml to 150 ml, 150 ml to 200 ml, 200 ml to 300 ml, 300 ml to 400 ml, 400 ml to 500 ml, 500 ml to 600 ml, 600 ml to 700 ml, 700 ml to 786 ml, or any range or combination of ranges therein. In an embodiment, the product volume may have a range of from 25 ml to 60 ml. In another embodiment, the product volume may have a range of from 40 ml to 70 ml. In another embodiment, the product volume may have a range of from 25 ml to 70 ml.

An embodiment of a packaged product is shown in FIG. 8. A packaged product 80 includes: (a) an aluminum container 83 that includes a heat seal coating on the interior surface that includes a sealing extension, (b) a lidding material 85 sealed to the aluminum container 83 at the sealing extension shown by a seal 87, and (c) a product 89 (a product fill line is shown to indicate the amount, e.g., volume, of the product in the aluminum container). The lidding material 85 in this embodiment is shown to include a peel tab 88 of triangular shape. The peel tab extends beyond a perimeter of the flat portion of the sealing extension and may include other shapes than that shown in FIG. 8. The peel tab 88 may aid a user with opening the packaged product 80 by allowing the user to more easily grasp the lidding material 85 and peel it away from the aluminum container 83 thereby allowing access to the product 89. In some embodiments, the lidding material may not include a peel tab.

The packaged product 80 shown in FIG. 8 may contain an alcoholic product such that the package resembles a shot glass (e.g., shooter) and may contain an equivalent amount of product that a typical glass shot glass would contain (e.g., approximately 2 ounces or 60 ml). The packaged product is not limited to aluminum containers shaped to resemble shot glasses or products that include alcohol.

In an embodiment, a packaged product includes an aluminum container having a sidewall that includes an interior surface and a sealing extension that includes the interior surface. The interior surface includes a heat seal varnish. The heat seal varnish includes a polypropylene wax dispersed in a polyester matrix. The container includes an opening having a diameter in a range of from 30 mm to 100 mm and a height in a range of from 30 mm to 100 mm. A product is contained in the aluminum container. A lidding material that includes a polypropylene sealing layer is sealed to the interior surface of the sealing extension that includes the heat seal varnish forming a peelable, hermetic seal.

In another embodiment, a packaged product includes an aluminum container having a sidewall that includes an interior surface and a sealing extension that includes the interior surface. The interior surface includes a heat seal varnish. The heat seal varnish includes a polypropylene wax dispersed in a polyester matrix. The container includes an opening having a diameter in a range of from 30 mm to 50 mm and a height in a range of from 50 mm to 70 mm. A product having a product volume in a range of from 25 ml to 70 ml and an alcohol content in a range of from 5% to 50% is contained in the aluminum container. A lidding material that includes a polypropylene sealing layer is sealed to the interior surface of the sealing extension that includes the heat seal varnish forming a peelable, hermetic seal.

The packaged product may be recyclable after its primary use. The term “suitable for recycling”, as used herein, is meant to indicate that the packaging materials can be converted into a new, useful item by means of reprocessing in a recycle stream. In one embodiment, once the lidding material has been at least partially removed from the aluminum container and the product has been removed (e.g., emptied package), the lidding material and/or the aluminum container may be recyclable. For example, when the lidding material and the aluminum container each include 90% or greater of aluminum by weight of the specified component (e.g., the lidding material, the aluminum container, or a combination thereof), the component may be recyclable. If the lidding material is completely removed from the aluminum container, the lidding material and the aluminum container may each be recyclable in an appropriate recycling stream. In another embodiment, the lidding material may remain partially attached to the aluminum container and the emptied package (lid and aluminum container) may be recycled together in one recycling stream.

The heat seal varnish that is a coating includes much less polymer content than films that are typically laminated to the interior surface of an aluminum container. It was surprisingly found that the heat seal varnish that constitutes a small portion of the aluminum container, especially for deeply drawn aluminum containers, (a) provides adequate bond strength of the aluminum container to the lidding material forming a peelable, hermetic seal, (b) resists corrosion and dissolution when a packaged product contains acidic or alcoholic product, (c) maintains oxygen barrier of the packaged product, and (d) includes a small amount of polymer solids (i.e., PET, PP) such that the polymer solids may not interfere with aluminum recycling processes. The term “dissolution”, as used herein, refers to partial or complete dissolvability of the heat seal varnish from the aluminum container.

### Method of Making Aluminum Container

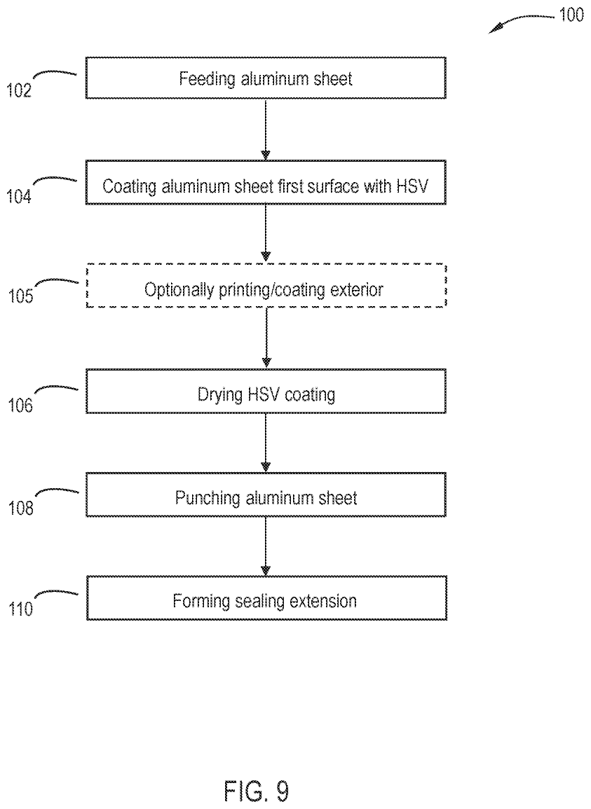

A method of making an aluminum container is disclosed herein. With reference to FIG. 9, a method 100 of making an aluminum container is shown.

At operation 102 of method 100, an aluminum sheet is fed into a coating station. The aluminum sheet includes a first surface and a second surface.

At operation 104 of method 100, the aluminum sheet first surface is coated with a heat seal varnish (HSV) in a wet state that includes a polypropylene wax dispersed in a polyester matrix. The heat seal varnish may include food grade solvents and includes a solids content in a range of from 35% to 60%.

Optionally, the aluminum sheet may undergo printing and/or coating on the second surface at operation 105 of method 100 by methods understood in the art. The sheet second surface printing and/or coating operation may take place after the operation of heat seal coating in the wet state. The optional printing and/or coating may contribute to aesthetics of the packaged product and/or communicating information to a user on the outer surface of the packaged product. In some embodiments, the sheet second surface printing and/or coating operation may take place before or simultaneously with the operation of heat seal coating in the wet state.

At operation 106 of method 100, the heat seal varnish is dried from the wet state to form a layer of heat seal varnish in a dry state by methods known in the art (e.g., heated oven). The heat seal varnish dry state may include a dry basis weight, indicative of remaining solids, in a range of from 3.0 grams per meter² (gsm) to 9.0 gsm (1.8 pounds per ream (lb/rm) to 5.5 lb/rm), or any range or combination of ranges therein. In an embodiment, the heat seal varnish may include a dry basis weight in a range of from 4.0 gsm (2.4 lb/rm) to 6.0 gsm (3.7 lb/rm). In another embodiment, the heat seal varnish dry basis weight may include a range of from 5.0 gsm (3.1 lb/rm) to 5.5 gsm (3.4 lb/rm). In other embodiments the heat seal varnish dry basis weight may be greater than 9.0 gsm (5.0 lb/rm). In other words, the thickness of the heat seal varnish in the dry state may be in a range of from 3 microns to 9 microns. Corrosion resistance of the heat seal varnish in the dry state may be greater than 100 double rubs (DR) when measured according to a Corrosion Resistance Solvent Rub Test, for example, as disclosed herein.

At operation 108 of method 100, an aluminum container is punched from the aluminum sheet that includes the heat seal varnish in a dry state. The punching process is well known by one of skill in the art of forming containers from aluminum (e.g., capsules for wine or liquor bottles, aluminum cups for single serve snacks, etc.). The punching operation forms a three-dimensional, aluminum container from the aluminum sheet having a sidewall, an opening (e.g., open end), and a closed end (e.g., bottom). The punching operation may include punching the sheet multiple times, (i.e., a second punch, a third punch, etc.) as known in the art. The aluminum container includes an exterior surface and an interior surface that includes the heat seal varnish in a dry state. The sidewall may include a thickness in a range of from a range of from 150 microns to 270 microns. The opening may include a diameter in a range of from 30 mm to 100 mm and a height in a range of from 30 mm to 100 mm. In some embodiments, the aluminum container may include a ratio of the height to the diameter (e.g., draw ratio) equal to or greater than 1.1.

At operation 110 of method 100, a sealing extension is formed that is an extension of the aluminum sidewall laterally away from the opening. The sealing extension includes a flat portion that may have a width in a range of from 1.0 mm to 5.0 mm. The sealing extension may additionally include a curved portion.

### Test Methods

### Corrosion Resistance Solvent Rub Test

The test conditions include standard conditions of between 20° C. and 25° C. (68° F. and 77° F.) and humidity levels between 30% and 50%. Samples are taken from the aluminum sheet that includes the heat seal varnish in the dry state. A total of 10 samples are prepared. Each sample includes dimensions of at least 20.0 cm by 20.0 cm. Sixteen layers of cotton cheesecloth are prepared with each layer approximately 7.62 cm by 7.62 cm (3.0 inches by 3.0 inches)). The layers of cheesecloth are stacked upon each other and secured (e.g., with an O-ring or wire) to the ball end of a 1 kg (2 pound) ball peen hammer. The cheesecloth is saturated with 100% methyl ethyl ketone (MEK) by volume. The hammer handle is placed into the palm of a tester's dominant hand such that the handle is parallel to the floor and the MEK saturated cheesecloth is resting on the heat seal varnish. No additional pressure should be used to hold the hammer. Slide the hammer (e.g., rub, stroke) in a first direction (e.g., forward) across a 10.16 cm (4.0 inches) length of the sample and slide the hammer back in an opposing second direction (e.g., backward) to the starting point. The combination of the stroke in the first direction and the second direction (e.g., one cycle, one back and forth motion) is equal to one rub. Continue to slide the hammer back and forth across the same location for a total of 100 rubs. Rub in a consistent, even manner. Ensure that the cheesecloth remains moist and pause rubbing to remoisten the cheesecloth if necessary. After 100 rubs of each sample, visually observe the sample for any loss of heat seal varnish. A passing test result includes no change in the heat seal varnish after the set number of rubs. Each of the 10 samples should pass (i.e., have no loss of heat seal varnish).

The above description and examples illustrate certain embodiments of the present disclosure and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

What is claimed is:

1. An aluminum container comprising:
a sidewall comprising an interior surface, a sealable extension comprising the interior surface and having a flat portion, an opening having a diameter in a range of from 30 mm to 100 mm, and a height in a range of from 30 mm to 100 mm;
wherein the interior surface comprises a heat seal varnish comprising a polypropylene wax dispersed in a polyester matrix, and wherein a seal between the interior surface of the sealable extension and a lidding material comprising a polypropylene sealing layer comprises a peelable hermetic seal.

2. The aluminum container of claim 1, wherein the sealable extension further comprises a curved portion.

3. The aluminum container of claim 1, wherein the flat portion comprises a width in a range of from 1.0 mm to 5.0 mm.

4. The aluminum container of claim 1, wherein the diameter has a range of from 30 mm to 50 mm.

5. The aluminum container of claim 1, wherein the heat seal varnish comprises a dry coat weight in a range of from 3.0 grams per meter² (gsm) to 9.0 gsm.

6. The aluminum container of claim 1, further comprising an aluminum content of from 90% to 100% by weight of the aluminum container.

7. The aluminum container of claim 1, wherein the lidding material further comprises aluminum.

8. The aluminum container of claim 7, wherein the lidding material further comprises an aluminum content of from 90% to 100% by weight of the lidding material.

9. The aluminum container of claim 1, wherein the aluminum container comprises an oxygen transmission rate of less than 0.005 cubic centimeters per meter² per 24 hours (cc/m²/24 hours) when measured at 23° C. and 0% relative humidity (RH) using ASTM D3985-05.

10. A packaged product comprising:
an aluminum container comprising a sidewall comprising an interior surface, a sealable extension comprising the interior surface and having a flat portion, an opening diameter having a range of from 30 mm to 50 mm, and a height having a range of from 50 mm to 70 mm;
a product comprising a product volume in a range of from 25 ml to 70 ml; and
a lidding material comprising aluminum and a polypropylene sealing layer;
wherein the interior surface comprises a heat seal varnish comprising a polyester matrix comprising a polypropylene wax, and wherein a seal between the polypropylene sealant and the interior surface of the sealable extension comprises a peelable hermetic seal.

11. The packaged product of claim 10, wherein the flat portion comprises a width in a range of from 1.0 mm to 5.0 mm.

12. The packaged product of claim 10, wherein the product comprises a liquid.

13. The packaged product of claim 10, wherein the product has an alcohol content in a range of from 5% to 50%.

14. The packaged product of claim 10, wherein the heat seal varnish comprises a dry coat weight in a range of from 3.0 grams per meter² (gsm) to 9.0 gsm.

15. The packaged product of claim 10, wherein the lidding material further comprises an aluminum content of from 90% to 100% by weight of the lidding material.

16. The packaged product of claim 10, further comprising an aluminum content of from 90% to 100% by weight of a combination of the aluminum container and the lidding material.

17. A method of making an aluminum container, the method comprising:
feeding an aluminum sheet having a first surface and a second surface into a coating station;
coating the aluminum sheet first surface with a heat seal varnish in a wet state;
drying the heat seal varnish to a dry state;
punching an aluminum container from the aluminum sheet and comprising an interior surface comprising the aluminum sheet first surface and an exterior surface comprising the aluminum sheet second surface;
forming a sealing extension comprising the interior surface and having a flat portion; and
wherein the heat seal varnish comprises the interior surface.

18. The method of making an aluminum container of claim 17, further comprising a printing and/or coating operation comprising applying printed indicia and/or a coating to the aluminum container exterior surface before the punching operation.
